(19) United States
(12) Patent Application Publication
(10) Pub. No.: US 2019/0266742 A1
(43) Pub. Date: Aug. 29, 2019

(54) ENTITY LOCATION PROVISION USING AN AUGMENTED REALITY SYSTEM

(71) Applicant: Lenovo (Singapore) Pte. Ltd., Singapore (SG)

(72) Inventors: Nathan J. Peterson, Oxford, NC (US); Rod D. Waltermann, Rougemont, NC (US); John Carl Mese, Cary, NC (US); Russell Speight VanBlon, Raleigh, NC (US)

(21) Appl. No.: 15/904,939

(22) Filed: Feb. 26, 2018

(51) Int. Cl. G06T 7/70; H04W 4/02; G06T 11/60

(52) U.S. Cl. CPC G06T 7/70; G06T 11/60; H04W 4/02

(57) ABSTRACT

One embodiment provides method, including: receiving, at an augmented reality system, a trigger event associated with an entity; determining a location of the entity, wherein the determining comprises identifying at least one characteristic of the entity; and providing, on the augmented reality system, an indication of the determined location. Other aspects are described and claimed.

### BACKGROUND

Advances in technology have increased the capabilities of information handling devices (“devices”), for example smart phones, tablet devices, smart speakers, smart TVs, laptop and personal computers, and the like. For example, many modern devices may be able to receive and process input using a plurality of new input methods such as through voice input, gesture input, gaze input, and the like. These modern devices may often be found intermixed with conventional information handling devices that may not contain these new interactive capabilities.

### BRIEF SUMMARY

In summary, one aspect provides a method, comprising: receiving, at an augmented reality system, a trigger event associated with an entity; determining a location of the entity, wherein the determining comprises identifying at least one characteristic of the entity; and providing, on the augmented reality system, an indication of the determined location.

Another aspect provides an information handling device, comprising: a display device; a processor; a memory device that stores instructions executable by the processor to: received, at an augmented reality system, a trigger event associated with an entity; determine a location of the entity, wherein to determine comprises identifying at least one characteristic of the entity; and provide, on the augmented reality system, an indication of the determined location.

A further aspect provides a product comprising: a storage device having code stored therewith, the code being executable by the processor and comprising: code that receives, at an augmented reality system, a trigger event associated with an entity; code that determines, at an electronic device, a location of the entity, wherein the determining comprises identifying at least one characteristic of the entity; and code that provides, on the augmented reality system, an indication of the determined location.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing an indication of a determined location of an entity.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An increasing number of users are utilizing augmented reality capable devices in daily life. However, the functionality of these augmented reality systems is still developing to link the virtual world to the physical world. As the function and capability of augmented reality systems increase, users demand further capability from a system to augment reality in their daily lives. For example, a user may wish to have information of an object that the user owns and has no preprogrammed data associated with the object. As another example, an object may be outside the user's field of view. As another example, the object may be unknown to the system until a user requests, either in video or audio form, further information about an object.

Conventionally, an augmented reality system may provide information for objects within a user's view. For example, if a user is looking at a piece of art, the augmented reality system may provide further information about the piece of art such as the artist, when the piece of art was created, or historical notes regarding the art. The further information may be visually displayed on a display screen associated with the augmented reality system, for example, a smartphone, tablet, hood, goggles, or the like. Additionally or alternatively, the information may be provided auditory information over speakers or headphones. However, the augmented reality system may not be able to obtain augmented reality information about an object outside of the user's field of view, particularly if the user is unaware of the object's location. However, users would like to receive information on the augmented reality system regarding entities or objects outside a field of view or an entity or entities or objects that may arrive at a user's location. For ease of readability, the term “entity” refers to a person, place, object, or the like.

Accordingly, an embodiment provides a method for an augmented reality system to locate an entity and provide information related to the location of the entity. Additionally, in an embodiment, the augmented reality system may identify an entity that may arrive at or proximate to a user location. For example, the system may provide information related to a package that arrives at a user's house. An embodiment receives a trigger event, for example, a user requesting information related to an entity, an entity coming to the user's location, or the like. As stated above, the entity may be an object, thing, person, place, or the like.

The system may then determine a location of the entity by identifying at least one characteristic of the entity. Identifying at least one characteristic may include identifying a feature of the entity that allows the system to determine which entity to identify the location of For example, the system, upon receiving input to find keys, may determine which keys are being requested. As another example, the system, upon receiving input indicating that a package has arrived, may determine one or more characteristics of the package. In an embodiment, a characteristic of the entity may be physical attributes of the entity (i.e., color, size, shape, or the like), biometric information of the entity (i.e., facial recognition, finger prints, retinal scans, physical attributes, clothing style, and the like), near field communication, bar codes (i.e., traditional barcode, QR codes, or the like).

Once the entity has been identified, the system may determine a location of the entity. This determination may be with respect to the user. In other words, the system may determine a location of the entity with respect to the user. The system may provide an indication of the determined location of the entity on the system or display associated with the system. In an embodiment, an indication of the determined location may be visual on a display screen such as a smartphone, tablet, computer, augmented reality hood, goggles, or the like. Additionally or alternatively to a visual display, the system may provide an indication of the entity location using audio, tactile, haptic, or the like, output.

The illustrated example embodiments will be best understood by reference to the figures. The following description is intended only by way of example, and simply illustrates certain example embodiments.

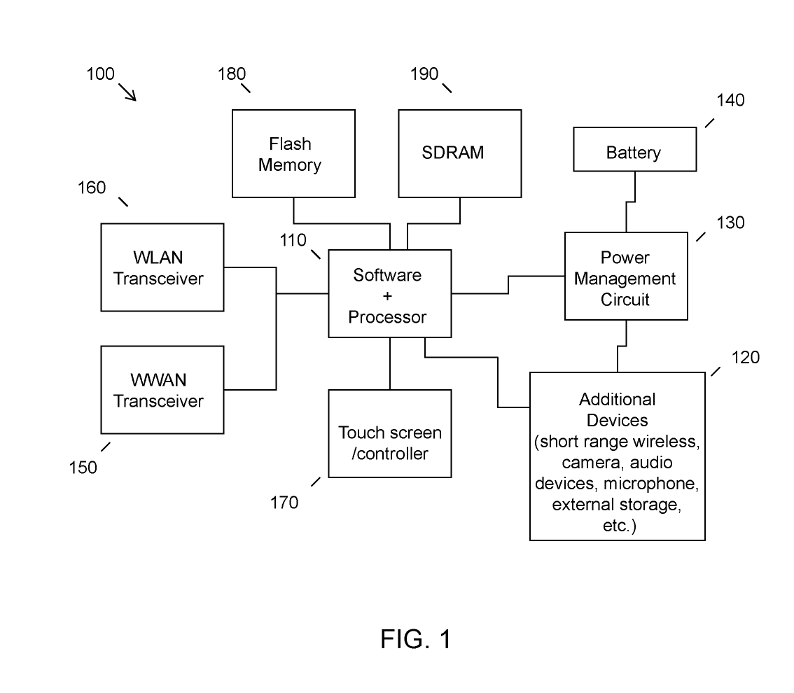

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes a touch screen 170 for data input and display/rendering. System 100 also typically includes various memory devices, for example flash memory 180 and SDRAM 190.

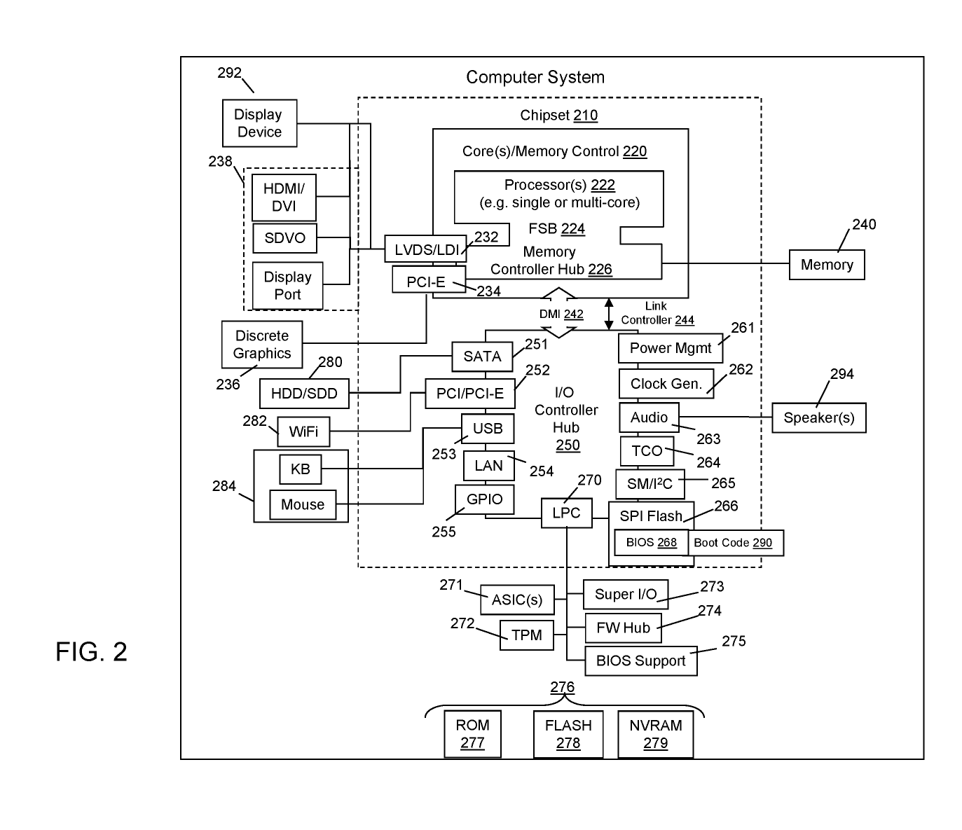

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, wearable headsets, personal computer devices generally, and/or electronic devices that are capable of displaying augmented reality content and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

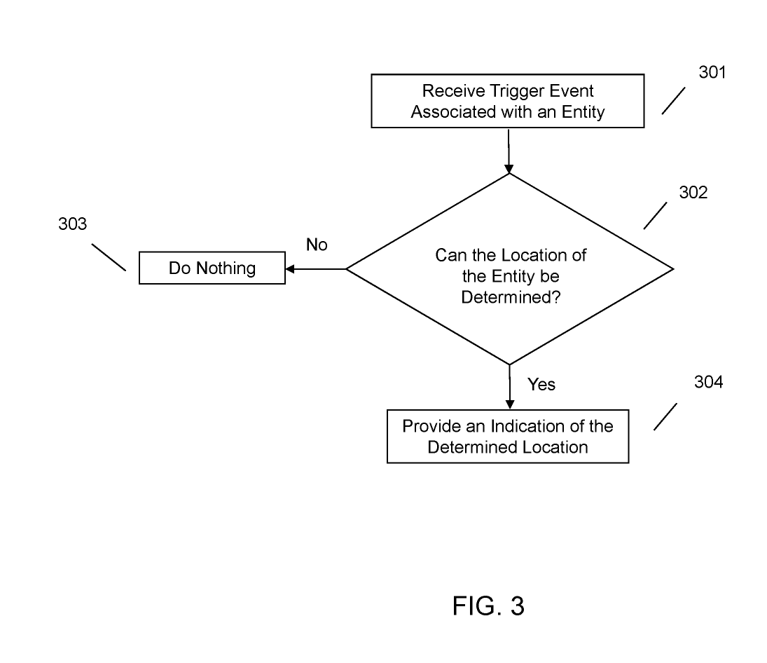

FIG. 3 illustrates an example method for providing an indication of an entity location to a user. At 301 an embodiment may receive a trigger event associated with an entity. In an embodiment, the trigger event may be any form of input such as text entry, voice input, gaze detection, gesture input, image captures, or the like. As an example, the system may receive voice input from a user. As another example, the augmented reality system may display of list or icons of entities, and may receive gaze input from the user selecting one of the entities. In one embodiment, the trigger event may be input received from a user, for example, a request from a user. For example, a user may provide a request that identifies an entity for the system to locate. For example, a user may ask the system, “Where are my car keys?”

In an embodiment, the trigger event may be the user arriving at a location. For example, the user may have a list and arrive at a store. The system may identify the arrival of the user as a trigger even. The system may then access the list, for example, using image capture techniques, accessing a data storage location associated with the list (e.g., if the list is in electronic form, etc.), or the like, and identify the entities included on the list. Alternatively, the trigger event may be the creation of the list. For example, if a user is creating a packing list, the system may identify the creation of the list as the trigger event. In an embodiment, the trigger event may be the arrival of an entity at the user's location or proximate to the user's location. For example, a person arriving at the front door of the house of the user of the augmented reality system may be treated as a trigger event. As another example, the trigger event may be a package left at the user's door. Alternatively, the trigger event may be a trigger event set by the user. For example, the user may set a reminder, alarm, or other notification that can act as a trigger event to the system.

The trigger event received at 301 triggers the system to attempt to determine the location of the entity associated with the trigger event at 302. For example, the user's arrival at a store with a list, the system may attempt to identify the location of the entities on the list within the stored. For example, a list may be a packing list. As another example, creation of a packing list may trigger the system to locate items or entities on the packing list. As another example, upon receipt of the user input to locate an item, the system may locate the item. As another example, upon arrival of an entity to the user's location, the system may identify the exact location of the entity.

In an embodiment, determining the location of entity includes identifying at least one characteristic of the entity. Identifying a characteristic of the entity may include determining what entity is associated with the trigger event. For example, if the user provides input requesting the system to provide a location of the user's keys, the system may identify an identifying feature of the user's keys (e.g., the type of keys, a color associated with the keys, which keys are associated with the user, etc.). In other words, the system may perform an analysis to determine which keys the user is looking for (e.g., one user's keys versus another user's keys, which keys are associated with the user, etc.). The system may automatically identify the characteristic, for example, as the user uses the system the system may associate objects with the user. Alternatively, the user may provide input that the system uses to identify the characteristic, for example, the user may provide an image of the entity, an identification tag associated with the entity, or the like.

Identifying the characteristic may also include identifying features of an entity once the entity is within a predetermined distance from the user or located at a predetermined location. For example, if a package arrives at the user's door, the system may identify characteristics of the object (e.g., sender, shape, size, etc.). As another example, if a person arrives at a location proximate to the user, the system may identify characteristics of the person (e.g., facial recognition, identification, etc.) to identify the person. In an embodiment, the entity may be a human or animal. The system may use characteristics such as facial recognition, fingerprint, retina scan, biometric data, height, weight, gait, mannerisms, clothing/accessories, voice, sound, or the like, to identify an entity. As another example, if the user walks into a store with a list, the system may attempt to identify entities provided on the list and then identify characteristics associated with those entities so that the entities can be located. In other words, identifying a characteristic allows the system to determine what entity is being requested or is within a proximate location to the user so that the system can provide output related to that entity.

Once one or more characteristics associated with the entity have been determined, the system may attempt to locate the entity, for example, using one or more sensors either integral to or accessible by the augmented reality system. In an embodiment, the electronic device detecting sensors may be integral to a user device capable of displaying augmented reality content such as an augmented reality headset (e.g., Google Glass®, Microsoft Hololens®, etc.), smart phone, tablet, and the like. For example, an augmented reality headset may be disposed with a camera capable of capturing images of entities. Alternatively, the electronic device detecting sensors may be disposed on another device and may transmit detected electronic device data to the user device. For example, image data associated with an entity may be captured by an independent camera that may subsequently transmit the captured image to the user's augmented reality device. Electronic device related data may be communicated from other sources to the user's augmented reality device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like. For simplicity purposes, the majority of the discussion herein will involve augmented reality content displayed on an augmented reality headset. However, it should be understood that generally any augmented reality-capable device may be utilized to display augmented reality content.

In an embodiment, the electronic device detecting sensors may be configured to continuously search for and detect electronic device related data by maintaining one or more sensors in an active state. The one or more sensors may, for example, continuously detect electronic device data even when other sensors (e.g., microphones, speakers, other sensors, etc.) associated with the AR device are inactive. Alternatively, the electronic device detecting sensors may remain in an active state for a predetermined amount of time (e.g., 30 minutes, 1 hour, 2 hours, etc.). Subsequent to not capturing any electronic device related data during this predetermined time window, an embodiment may switch the electronic device detecting sensors to a power off state. The predetermined time window may be preconfigured by a manufacturer or, alternatively, may be configured and set by one or more users. In another embodiment, the electronic device detecting sensors may attempt to detect an electronic device responsive to receiving a user command to detect. For example, a user wearing an augmented reality headset may be looking in a particular direction and provide a command input (e.g., voice input, touch input, gesture input, etc.) to begin detecting for an electronic device in the user's field of view.

In an embodiment, one of the system's detecting sensors may be an image capture device such as a camera. The camera may capture one or more images of the entity that may then be compared against a database of images of entities or identifers associated with entities. In an embodiment, identifiers may include bar codes, quick response (QR) codes, near field communication (NFC) signals, or the like. Responsive to identifying a match between the entity in the captured image and at least one entity in the database of images, an embodiment may conclude that the entity identity has been determined. An embodiment may further access any data associated with the at least one entity in the database. For example, each entity in the database may comprise entity identification data associated with it that may list and/or elaborate on one or more aspects of the entity. An embodiment may therefore associate the listed aspects of the entity in the database with the detected entity.

The augmented reality system may utilize many methods to determine a location of an entity. In an embodiment, determining a location of an entity may include using static or video image data. For example, a user may query the system to locate a set of car keys and the car keys may be out of a line of sight to the user. For example, a user may query the location of the car keys from the kitchen and the car keys are located in the living room. It should be noted that the entity does not have to be out of a line of sight to the user. In an embodiment, the system may use video image data to locate the out of sight car keys, for example, by accessing video cameras located in other rooms or locations. The image capture devices may include security cameras, image capture devices set upon the rooms, or devices having image capture devices (e.g., smartphones, smart televisions, tablets, personal computing devices, etc.). The video image data may be a live video feed, a historical captured video data source, or the like. In order to determine a video or image capture device to access, the system may utilize a “last known” location of an entity and access image capture devices located in that location. Alternatively, the system may access all image capture devices.

The system may then parse the video image data and comparing the parsed video image to at least one characteristic of an entity. The system may correlate video image data to a characteristic of an entity. For example, if a user queries the system for a location of the user's car keys, the system may utilize characteristics of the user's car keys such as the physical appearance of the keyring of the user's keys to correlate to entities parsed from the image data to determine the location of the user's keys. In other words, the system may compare the identified characteristic with the parsed image data to determine if the entity is included in the image data. For example, the shape, size, color, auto manufacturer, or the like, may be used to identify the keys associated with the user query. In this way the system may distinguish the car keys of the user's query from any other car keys that may be located within the building. For example, the system may parse the image data to differentiate the roommate's keys from the user's keys.

In an embodiment, determining the location of an entity may include utilizing a communication signal. For example, the entity may have an identifier associated with it, for example, the entity may have a near field communication tag or other identification tag associated with it. Communication or identifier tags may include barcodes, quick response (QR) codes, radio frequency identification (RFID) tags, BLUETOOTH®, or the like. The system may then access transmission data to identify where the entity is with respect to one or more receivers or other devices that can capture the identification. For example, the entity may contain an RFID device read by a sensor in the space of the entity and in communication with the augmented reality system. As another example, an entity may have a barcode or QR code label affixed to the entity, and image data received from image capturing devices in the space with the entity many identify the entity's location and relay that information to the augmented reality system. Communication between the entity's NFC identifier and the augmented reality system may be direct or relayed through additional system components.

In an embodiment, the augmented reality system may determine a location of the entity with respect to a current location of a user using a time of flight calculation. In an embodiment, time of flight may refer to the time required for a signal associated with an entity to travel a predetermined distance, for example, the distance between the entity and the augmented reality system. Additionally or alternatively, the time of flight calculation may include the time it takes for a user to travel from one location to another. Time of flight calculation may be used in a location for which there may be no sensors to locate an entity. If the system attempts to determine a location of an entity using image data, there may be areas in which there is no image data capture device. For example, if a system does not contain an image capture means in a master bedroom, the system may use time of flight to determine the possibility that an entity may be in the master bedroom in which no image capture data are available. In other words, if the system located a last known location of an entity in a room adjacent to the master bedroom, then time of flight calculations could determine the probability that the entity may have moved to the master bedroom. These calculations may be based on the temporal and spatial variables of entity movement, as well as other entities that may have moved the identified entity.

If the location of the entity cannot be determined at 302, the system may do nothing at 303. Alternatively, the system may provide an indication of the inability to find the entity to the user. This output may be visual, audible, tactile, haptic, or the like. Additionally or alternatively, the system may place an entity than cannot be located in a list in which the system continues to search for the unfound entity. The system may provide an indication to a user if the unfound entity's location is determined at some point in the future.

If, however, the system can determine the location of the entity at 302, the system may provide an indication of the determined location of the entity at 304. In an embodiment, the indication may comprise a visual indication, an audible indication, a haptic indication, a combination thereof, and the like. With respect to the visual indication, an embodiment may display one or more augmented reality icons on a portion of the display (e.g., at a location proximate the electronic device, at a predetermined location on a display, etc.). Each of the augmented reality icons may correspond to an icon or image for the identified entity or location. For example, if a user queries the system to find car keys, then the system may provide an icon or an image of the car keys. For example, the system may display an image from the captured image data of the keys sitting on the coffee table in the living room either at the present time or when the system last identified the location of the keys. Additionally or alternatively, the system may provide a name of the location of the identified entity. For example, the system may display or audibly indicate to a user the keys are located in the living room.

As another example, the system may provide directions to the identified entity or an icon or picture of the identified entity location. With respect to the audible indication, an embodiment may audibly describe (e.g., using one or more speakers, etc.) the directions or location of the identified entity. For example, the system may provide an arrow pointing towards the identified entity serving as a navigation system for a user, for example, as an overlay image on the augmented system display. The system may also give a distance from a user to the identified entity. In other words, the system may provide an indication that provides the user with the information needed to locate the entity. As another example, in the example of an entity arriving at the user's location, the system may provide an image of the entity on the augmented system display. In other words, the system provides a way for the user to “look through walls” to find an entity or to identify an entity that has arrived at the user's location. Additionally, the system may provide other information related to the entity. For example, if the entity arrives at the user's location, the system may identify the entity and inform the user of this information.

Such a system provides a technical improvement to current entity location systems. The described system provides a technique for finding entities that may be hidden from the user. Thus, instead of the user having to go through every room, the system provides a technique for identifying the location of the entity within the building that is more efficient and effective than the traditional method of manually looking for the entity. In other words, the system provides a technique for allowing the user to “look through walls” that is not provided using conventional techniques.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an augmented reality system, a trigger event associated with an entity;
determining a current physical location of the entity, wherein the determining comprises identifying at least one characteristic of the entity; and
providing, on the augmented reality system, an indication of the current physical location of the entity.

2. The method of claim 1, wherein the receiving a trigger event comprises receiving user input requesting a location of an entity.

3. The method of claim 1, wherein the receiving the trigger event comprises receiving an indication of arrival of an entity.

4. The method of claim 1, wherein the determining comprises accessing video image data to determine the location of the entity.

5. The method of claim 4, wherein the determining further comprises parsing the video image data and comparing the parsed video image data to the at least one characteristic of the entity.

6. The method of claim 1, wherein the determining comprises capturing an identifier associated with the entity.

7. The method of claim 1, wherein the determining comprises identifying a location of the entity with respect to a current location of the user using a time of flight calculation.

8. The method of claim 1, wherein the identifying at least one characteristic comprises identifying the entity and obtaining characteristics associated with the identified entity.

9. The method of claim 1, wherein the providing a notification comprises providing a notification of a direction of the entity with respect to the user on a display of the augmented reality system.

10. The method of claim 1, wherein the providing a notification comprises providing a notification of the location of the entity on a display of the augmented reality system by overlaying an image of the entity on an image of the location of the entity.

11. An information handling device, comprising:
a display device;
a processor;
a memory device that stores instructions executable by the processor to:
received, at an augmented reality system, a trigger event associated with an entity;
determine a current physical location of the entity, wherein to determine comprises identifying at least one characteristic of the entity; and
provide, on the augmented reality system, an indication of the current physical location of the entity.

12. The information handling device of claim 11, wherein the receiving a trigger event comprises receiving user input requesting a location of an entity.

13. The information handling device of claim 11, wherein the receiving the trigger event comprises receiving an indication of arrival of an entity.

14. The information handling device of claim 11, wherein the determining comprises accessing video image data to determine the location of the entity.

15. The information handling device of claim 14, wherein the determining further comprises parsing the video image data and comparing the parsed video image data to the at least one characteristic of the entity.

16. The information handling device of claim 11, wherein the determining comprises capturing an identifier associated with the entity.

17. The information handling device of claim 11, wherein the determining comprises identifying a location of the entity with respect to a current location of the user using a time of flight calculation.

18. The information handling device of claim 11, wherein the identifying at least one characteristic comprises identifying the entity and obtaining characteristics associated with the identified entity.

19. The information handling device of claim 11, wherein the providing a notification comprises providing a notification of a direction of the entity with respect to the user on a display of the augmented reality system.

20. A product comprising:
a non-signal storage device having code stored therewith, the code being executable by the processor and comprising:
code that receives, at an augmented reality system, a trigger event associated with an entity;
code that determines, at an electronic device, a current physical location of the entity, wherein the determining comprises identifying at least one characteristic of the entity; and
code that provides, on the augmented reality system, an indication of the current physical location of the entity.
